(19) United States
(12) Patent Application Publication
(10) Pub. No.: US 2007/0094522 A1
(43) Pub. Date: Apr. 26, 2007

(54) SYSTEM AND METHOD FOR OVERCLOCKING A CENTRAL PROCESSING UNIT

(76) Inventor: Ming-Lung Lee, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,924

(22) Filed: May 26, 2006

(30) Foreign Application Priority Data
Oct. 25, 2005 (CN) 200510100766.8

(51) Int. Cl. G06F 1/00

(52) U.S. Cl. 713/300

(57) ABSTRACT

A method for overclocking a CPU is provided. The method includes the steps of: receiving a desired frequency; reading a current working frequency of the CPU; determining whether the current working frequency equals the desired frequency; determining whether the current working frequency is less than the desired frequency if the current working frequency does not equal the desired frequency; increasing the current working frequency by 1 MHz, if the current working frequency is less than the desired frequency; decreasing the current working frequency by 1 MHz, if the current working frequency is larger than the desired frequency. A related system is also disclosed.

### FIELD OF THE INVENTION

The invention is related to a system and method for overclocking a central processing unit (CPU).

### DESCRIPTION OF RELATED ART

The development of information technology, has led people to adopt its advantages more and more. From governments to enterprises to households and to individuals, people are ever more dependant on electronic devices. The speed of data processing systems, or computing systems, needs to be faster in order to improve convenience and efficiency.

The heart of the data processing system is the CPU. The CPU can be viewed as an integrated circuit (IC) for processing internal operations, interface controls, and data storage. Computing operations, data input, output, and linkage to storage devices in the data processing systems are performed and controlled by the CPU.

A faster CPU is required as the CPU performs more and more operations, otherwise the CPU would perform operations at a slower speed. A faster CPU also means that the working frequency of the CPU is increased. The technique of overclocking a CPU is a better method to increase the working frequency of the CPU than to replace the current CPU with a faster CPU.

The technique of overclocking is to make the CPU run at a higher speed by adjusting the working frequency to be above the normal frequency. For example, adjusting the working frequency of Pentium 4 2.4 to 2800 MHz can make it achieve the level of Pentium 4 2.8, thus improving the speed of the CPU.

Conventional methods of overclocking for changing the working frequency of the CPU is to manually increase frequency desired in adjustment steps. Such a manual method can adjust a highest frequency, however the scope of each adjustment steps has no restriction, thus resulting in the instability of operating system. Users usually do not know how to adjust working frequency while keeping the operating system stable, thus a lot of problems may occur, such as, hardware and software incompatibility, or even destroying valuable data in the hard disk.

What is needed, therefore, is a system and method for overclocking a CPU that restricts a scope of adjustment step, consequently making the adjustment of working frequency of the CPU change smoothly, and enhancing the stability of the operation system.

### SUMMARY OF INVENTION

A system for overclocking a CPU in accordance with a preferred embodiment is provided. The system includes: a receiving module for receiving a desired frequency; a reading module for reading a current working frequency of the CPU; a judging module for determining whether the current working frequency of the CPU equals the desired frequency, and further for determining whether the current working frequency of the CPU is less than the desired frequency if the two frequencies do not equal; a frequency adjusting module for adjusting the current working frequency of the CPU according to the desired frequency; and a data accessing module for storing the current working frequency of the CPU if the current working frequency equals the desired frequency.

Another preferred embodiment provides a computer-based method for overclocking a CPU. The method includes the steps of: receiving a desired frequency; reading a current working frequency of the CPU; determining whether the current working frequency equals the desired frequency; determining whether the current working frequency is less than the desired frequency if the current working frequency does not equal the desired frequency; increasing the current frequency by a predetermined unit if the current working frequency is less than the desired frequency; decreasing the current frequency by a predetermined unit if the current working frequency is bigger than the desired frequency.

Other advantages and novel features of the present invention will be drawn from the following detailed description of a preferred embodiment and preferred method with the attached drawings.

### BRIEF DESCRIPTION OF DRAWINGS

FIG. 1 is a schematic diagram of hardware and software infrastructure of a system for overclocking a CPU in accordance with a preferred embodiment; and

FIG. 2 is a flowchart of a preferred method for overclocking a CPU by utilizing the system of FIG. 1.

### DETAILED DESCRIPTION

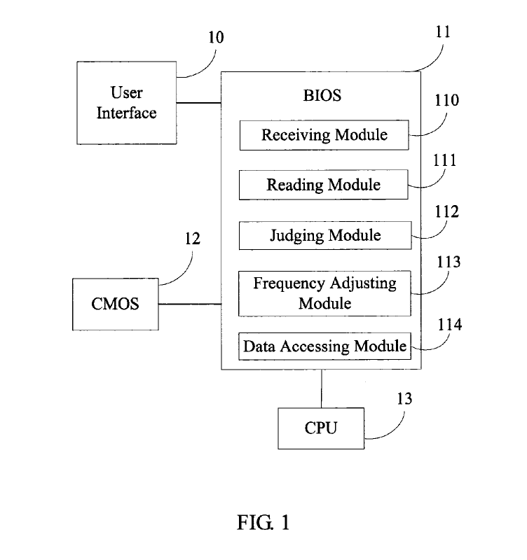

FIG. 1 is a schematic diagram of hardware and software infrastructure of a system for overclocking a CPU (hereinafter “the system”) in accordance with a preferred embodiment. The system typically includes a user interface 10, a Basic Input/Output System (BIOS) 11, a Complementary Metal-Oxide-Semiconductor Transistor (CMOS) 12, and a CPU 13.

The user interface 10 provides an interface for adjusting the working frequency of the CPU 13. The BIOS 11 includes a receiving module 110, a reading module 111, a judging module 112, a frequency adjusting module 113, and a data accessing module 114. The receiving module 110 is used for receiving a desired frequency of the CPU 13. The reading module 111 is used for reading a current working frequency of the CPU 13. The judging module 112 is used for determining whether the current working frequency of the CPU 13 equals the desired frequency, and further for determining whether the current working frequency of the CPU 13 is less than the desired frequency if the two frequencies do not equal. The frequency adjusting module 113 is used for adjusting the current working frequency of the CPU 13 to the desired frequency. The data accessing module 114 is used for storing the current working frequency of the CPU 13 in the CMOS 12 if the current working frequency equals the desired frequency.

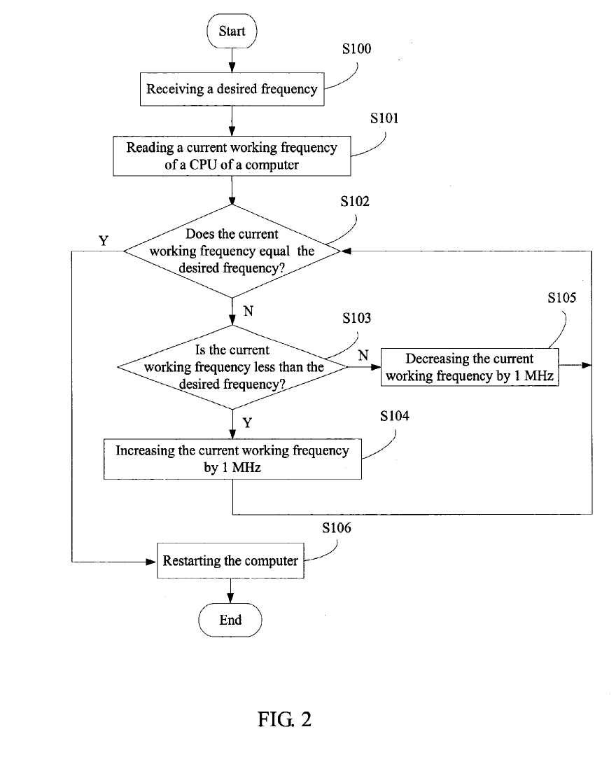

FIG. 2 is a flowchart of a preferred method for overclocking the CPU 13 by utilizing the system of FIG. 1. In step S100, the receiving module 110 receives a desired frequency. In step S101, the reading module 111 reads a current working frequency of the CPU 13. In step S102, the judging module 112 determines whether the current working frequency equals the desired frequency. If the current working frequency does not equal the desired frequency, in step S103, the judging module 112 further determines whether the current working frequency is less than the desired frequency. If the current working frequency is less than the desired frequency, in step S104, the frequency adjusting module 113 increases the current working frequency by 1 MHz. Then, the procedure returns to step S102 described above.

If, in step S103, the judging module 112 determines that the current working frequency is larger than the desired frequency, in step S105, the frequency adjusting module 113 decreases the current working frequency by 1 MHz. Then, the procedure returns to step S102 described above.

If, in step S102, the judging module 112 determines that the current working frequency equals the desired frequency, in step S106, the data accessing module 114 stores the current working frequency in the CMOS 12, and the CPU 13 restarts the computer according to the current working frequency stored in the CMOS 12.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for overclocking a central processing unit (CPU), the system comprising:
a receiving module for receiving a desired frequency;
a reading module for reading a current working frequency of the CPU;
a judging module for determining whether the current working frequency of the CPU equals the desired frequency, and further for determining whether the current working frequency of the CPU is less than the desired frequency if the two frequencies do not equal;
a frequency adjusting module for adjusting the current working frequency of the CPU according to the desired frequency; and
a data accessing module for storing the current working frequency of the CPU if the current working frequency equals the desired frequency.

2. The system according to claim 1, wherein the frequency adjusting module increases the current working frequency by a predetermined unit if the current working frequency is less than the desired frequency.

3. The system according to claim 2, wherein the frequency adjusting module deceases the current working frequency by a predetermined unit if the current working frequency is larger than the desired frequency.

4. The system according to claim 3, wherein the predetermined unit is 1 MHz.

5. A computer-based method for overclocking a central processing unit (CPU), the method comprising the steps of:
receiving a desired frequency;
reading a current working frequency of the CPU;
determining whether the current working frequency equals the desired frequency;
determining whether the current working frequency is less than the desired frequency if the two frequencies do not equal; and
increasing the current working frequency by a predetermined unit, if the current working frequency is less than the desired frequency;
decreasing the current working frequency by a predetermined unit, if the current working frequency is larger than the desired frequency.

6. The method according to claim 5, wherein the predetermined unit is 1 MHz.

7. The method according to claim 5, further comprising the step of storing the current working frequency if the current working frequency equals the desired frequency.
